(19) United States
(12) Patent Application Publication
(10) Pub. No.: US 2003/0179096 A1
(43) Pub. Date: Sep. 25, 2003

(54) Smoke detector and door bell kit with wireless remote audio alarm

(76) Inventor: Eytan Hanan, Teaneck, NJ (US)

Correspondence Address: FOLEY & LARDNER, 777 EAST WISCONSIN AVENUE, SUITE 3800, MILWAUKEE, WI, 53202-5308, US

(21) Appl. No.: 10/353,504

(22) Filed: Jan. 29, 2003

Related U.S. Application Data
(60) Provisional application No. 60/366,909, filed on Mar. 22, 2002.

(51) Int. Cl. G08B 17/10

(52) U.S. Cl. 340/628; 340/539.1; 340/521

(57) ABSTRACT

A wireless fire detection and door bell system includes a smoke detector having a first transmitter; a door bell button having a second transmitter and a chime providing two different audio signals in response to the first and second transmitters respectively.

### CROSS-REFERENCE TO RELATED PATENT APPLICATIONS

This application claims priority to U.S. Provisional Application Serial No. 60/366909 entitled Smoke Detector with Wireless Remote Audio filed on Mar. 22, 2002 and invented by Eytan Hanan, which is incorporated herein by reference.

### BACKGROUND OF THE INVENTION

The present invention relates generally to a smoke detection device which, in the event smoke is detected transmits a wireless signal to a remote audio alarm, and more particularly to a kit for sale in a retail outlet including a smoke detector, and a door bell, and a single alarm.

Smoke detectors are widely known in the prior art and fall generally into one of two types. Common inexpensive smoke alarms are widely available as individual units which contain audio alarms and may be mounted anywhere. These have the drawback that if the detector is mounted in a distant location such as a basement or an outside shed, the alarm may not reach the ears of someone in the house in time to take appropriate action. The second type of smoke detector is a central monitoring system which is complicated and difficult and expensive to install.

It is therefore an object of the present invention to provide an inexpensive smoke detector which is easily installed and transmits a wireless signal warning of a fire condition in a remote location.

It is a further object of the present invention to transmit a smoke detection warning by wireless signal to a door bell chime, to provide warning of a fire condition in a remote location.

It is a further object of the present invention to provide a smoke detector connected by wireless means to a remote audio alarm which complies with FCC transmission restrictions.

It is still another object to provide a smoke detector and door bell that are connected by wireless means to a single remote audio alarm.

It is another object to provide a smoke detector and a door bell button that provide different wireless signals to a single alarm unit.

It is still another object to provide two different audio signals by the alarm unit in response to the smoke detector and door bell button respectively.

It is still a further objective that the audio signal generated in response to the smoke detector is an alarm sound and the audio signal generated in response to the door bell button is more pleasant, being lower in decibel, and/or overall duration of time.

It is yet another object to provide a kit containing at least one smoke detector, at least one door bell button, and chime, where the smoke detector contains a first wireless transmitter and door bell button contain a second wireless transmitter having a frequency different than the first transmitter.

A further objective is provide unique transmitting signals in each kit, so that the smoke detector and door bell transmitters would not be recognized by the alarm receiver of another kit. This prevents alarms from sounding off in other homes in instances when two neighbors buy the same product.

Each of the objectives and features identified herein, may be used either alone or in combination with any other objective or feature.

### SUMMARY OF THE INVENTION

In accordance with these and other objects, the present invention is a smoke detector connected by wireless means to a remote audio alarm. The device comprises a photoelectric sensor for determining the presence of smoke and wireless transmission means for transmitting the signal to a remote audio alarm. In one embodiment, the remote audio alarm is a comprised of a door bell chime.

Another embodiment of the invention relates to a wireless fire detection and door bell system including a wireless smoke detector having a first transmitter and a replaceable power source and a wireless door bell having a button and a second transmitter activated by depressing the button. The door bell includes a second replaceable power source. An alarm includes a receiver and means for producing a first signal in response to the first transmitter and a second signal in response to the second transmitter.

In another embodiment a security kit for sale in a retail outlet includes a wireless smoke detector having a transmitter providing a first signal, a wireless door bell having a second transmitter providing a signal different than the first signal; and an alarm having a receiver and means for producing a first audio signal in response to the first transmitter and a second different audio signal in response to the second transmitter.

Another aspect of the invention is a method of providing a security kit for sale in a retail outlet to a consumer including providing a first smoke detector having a first wireless transmitter transmitting a first signal; providing a door bell button having a second wireless transmitter transmitting a second signal different than the first signal; and providing an alarm with a receiver configured to receive the first and second signals from the first and second transmitters and to provide a distinct audio signal in response to the first and second transmitters respectively.

### BRIEF DESCRIPTION OF THE DRAWINGS

FIG. 1 is a schematic of a smoke detector.

FIG. 2 is a schematic of a door bell chime and door bell button.

FIG. 3 is a schematic of another smoke detector, bell and door bell button.

FIG. 4 is a front view of the smoke detector, bell and door bell button.

FIG. 5 is a rear view of the smoke detector, bell and door bell button.

### DETAILED DESCRIPTION OF THE PREFERRED EMBODIMENTS

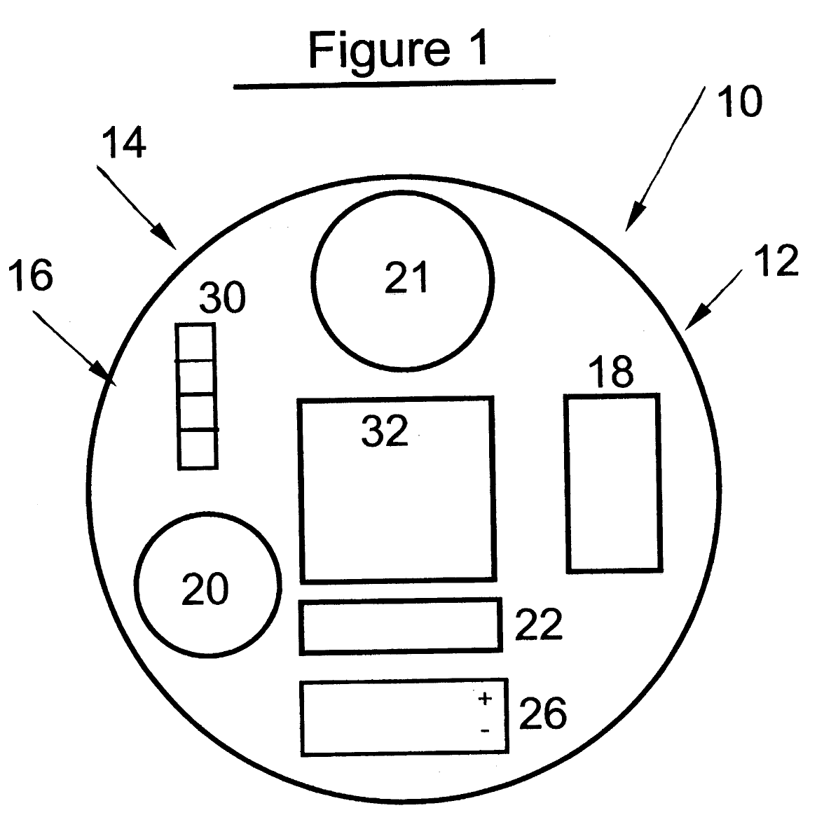

Referring to FIG. 1, a smoke detector 10 includes an enclosure 12 with a circular front face 14 and a periphery 16 formed therearound having a plurality of inhalation vents formed therein. The unit is powered by a 9 V DC battery 18. The smoke sensor 20 is an ionization smoke sensor or photoelectric sensor typically employed in conventional smoke detection systems. Upon sensing smoke, the smoke sensor signals by wireless means 22 to a remote audio alarm 24, which in the preferred embodiment is a door bell chime

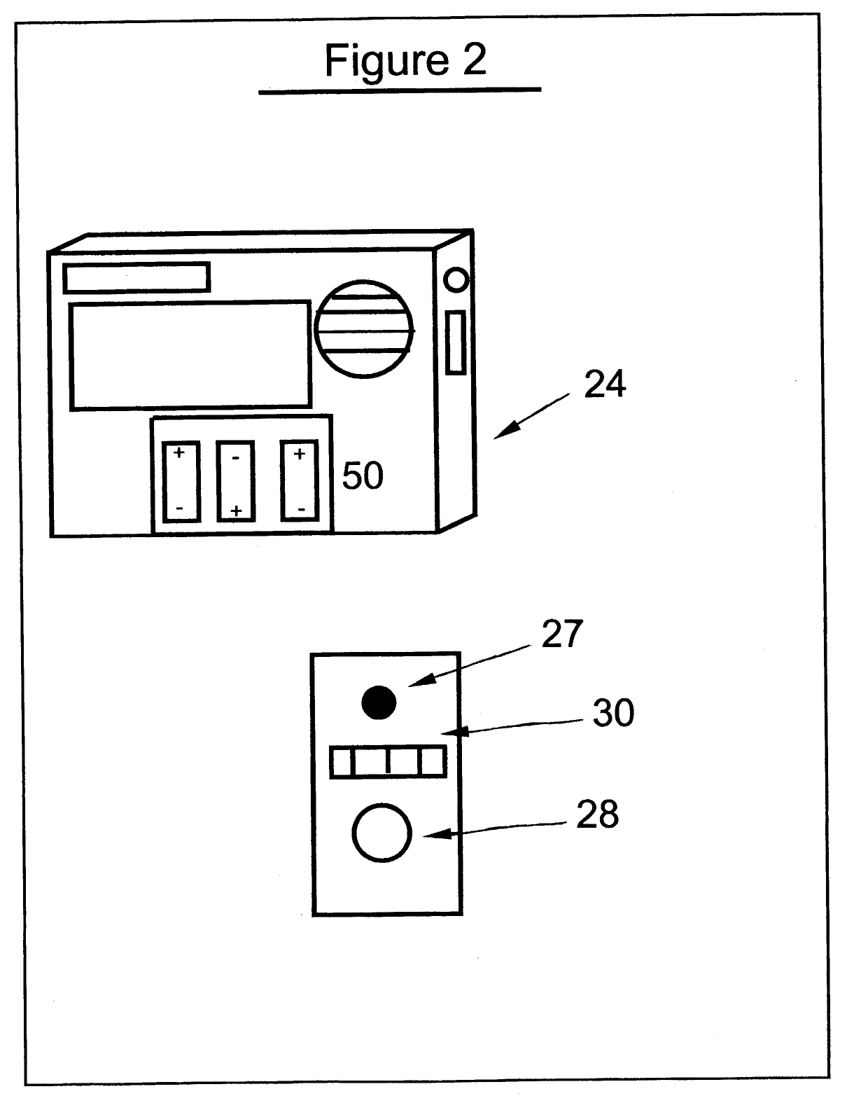

The door bell chime 24 is shown in FIG. 2. The door bell chime unit 24 may be powered either by 3 size C batteries or by 4.5 v DC power. Upon reception of a signal from the smoke detector 10, the door bell chime 24 rings in a different manner from that when a visitor presses the door bell button 28. Optionally, a separate door bell chime or alarm which is specifically designated to monitor the smoke detector may be installed in a different location from the door bell chime.

Smoke detector 10 may also include switches 30 to program the specific channel or frequency to transmit the wireless signal to the door bell chime 24. The smoke sensor 20, power source 26, switches 30 and wireless means such as a transmitter 22 are operatively connected with printed circuit board 32. Similarly, door bell button 28 may also include a transmitter that sends a signal to the door bell chime receiver when the button is depressed by a visitor. The door bell button 28 may also include switches to allow the user to select the channel or frequency to transmit the wireless signal to the door bell chime.

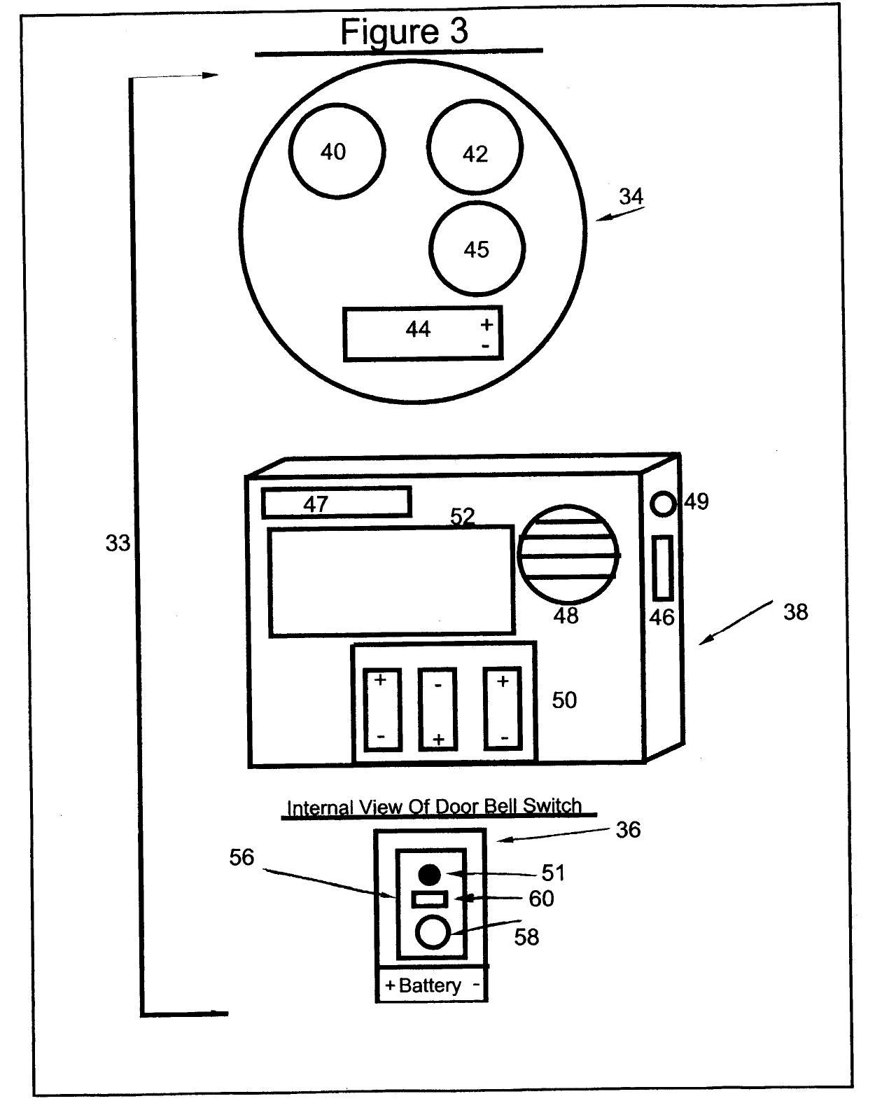

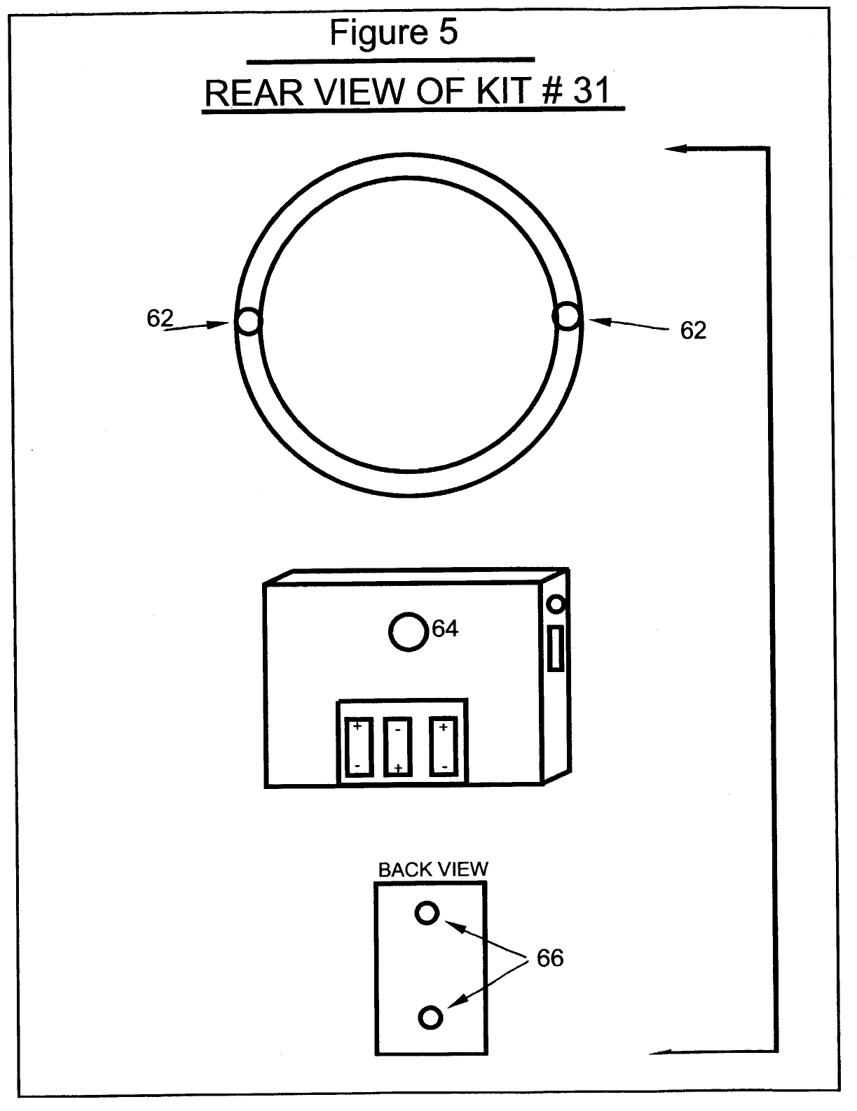

Referring FIGS. 3-5, a security kit 33 includes a smoke detector 34, a door bell switch 36 and a door bell 38. While many of the components of the smoke detector 34, door bell switch 36 and door bell are the same, in order to avoid confusion, new reference numbers will be applied to the various components in FIGS. 3-5. It is noted that these components may also include any or all of the components shown in FIGS. 1 and 2 and discussed above. Smoke detector 34 includes a smoke sensor 40, an alarm transmitter 42 and a power source 44. In one embodiment, the power source 44 is a replaceable 9 V battery. Smoke detector also includes an onboard alarm 45 that is operatively connected to the other smoke detector components. The alarm produces an audio signal or tone to alert when smoke and/or fire is detected.

Alarm or door bell 38 includes a three position: off; low volume; and high volume 46, an audio component or bell 48, a replaceable power source 50 including three size C batteries, and a receiver 52. Each of the components of the bell device 38 are operatively connected to an electronic printed circuit board 54. The third major component in the security kit 33 is a door bell button or switch 36 having an electronic printed circuit board 56 operatively connecting a button 58 and a transmitter 60. When button 58 is depressed or otherwise switched a wireless signal is transmitted to the bell device 38. Additionally, doorbell switch 36 includes an indicator light 51 that is turned on when the button 58 is pressed.

In one embodiment both the transmitter 42 of the smoke detector 34 and transmitter 60 of the door bell switch 36 transmits a signal at 315 Mhz. Of course other frequencies may be used as well. If the transmitted signal is the same for the smoke detector and door bell switch the bell device would produce the same audio signal in response to the smoke detector transmitter and the door bell button transmitter. Alternatively, transmitters 36 and 60 may provide a distinct code over the same frequency to permit the receiver to differentiate from the smoke detector and door bell button and provide a unique audio response to the smoke detector and door bell button respectively.

It is also anticipated that transmitters 36, and 60 may transmit a signal at different frequencies, that would be identified by the receiver 52 on the door bell 38. Whether there are two separate frequencies or two separate codes on the same frequency, it is preferably that alarm or door bell 38 provide at least two separate and distinctive audio sounds that are made in response to the differentiate between the two signals that are received from the smoke detector and the door bell button. The first audio signal generated by door bell 38 in response to the smoke detector is preferably a loud alarm style sound. In contrast, the second audio signal generated by door bell 38 in response to the door bell button to preferably a more pleasant sound such as a chime. However, other audio sounds may be generated in response to the two different transmitting devices, so that the occupant can discern whether a guest is at the door or whether there is a fire hazard.

The security kit 33 may be sold as a single package in a retail outlet, or maybe sold as individual items that can be purchased individually by a consumer. If the security kit 33 is sold as a single package, it is possible to ensure that the transmitters and receivers are compatible allowing the receiver to be able to distinguish between the smoke detector and door bell signals and respond with a different audio signal.

Since, the security kit 33 is to be sold in retail outlets, it is possible that neighbors may purchase the system. The kits may be packaged and assembled such that the each kit includes unique transmitting signals in, so that the smoke detector and door bell transmitters would not be recognized by the alarm receiver of another kit. The number of unique pairs of transmitting signals needs to be sufficient to minimized the possibility of two neighbors purchasing the same signal pair. This prevents alarms from sounding off in other homes in instances when two neighbors buy the same product.

Additionally, each kit 33 includes mounting brackets and/or fasteners 62, 64, for the smoke detector 34, and door bell switch 36 respectively for securing the smoke detector 34 and door bell switch 36 to a structure, such as a house or shed. The alarm or door bell 38 may be portable and moved from room to room in a house or even outside of the house. The door bell 38 may also include a mounting bracket and/or fastener 66 to secure the door bell to a structure if desired. This allows a user to be alerted to either the smoke detector or the door bell switch when working outdoors. The transmitters 42 and 60 have a range of approximately 200 feet in a preferred embodiment. This allows the consumer to move the door bell upto 200 feet away from the smoke detector and door bell switch and still receive the signal. Of course the range could be modified depending on the environment that it will be used.

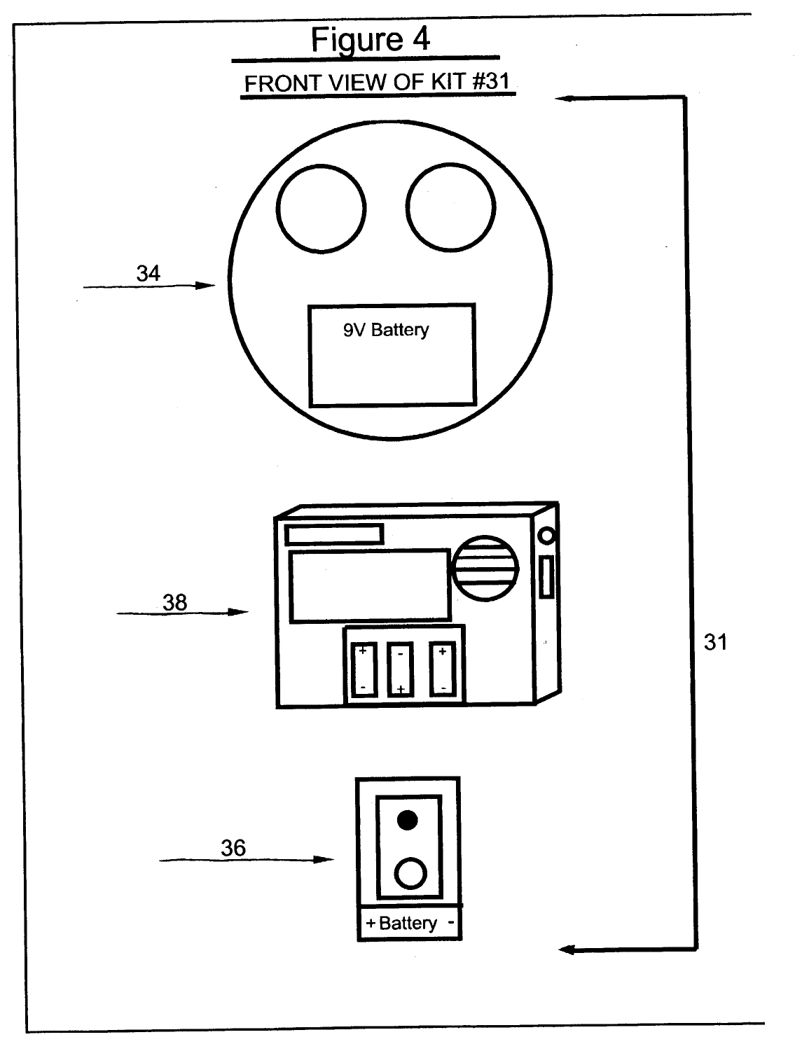

Referring to FIG. 4 is the front face of each of the smoke detector 34, door bell switch 36 and alarm or door bell 38.

The door bell switch 36 is wireless so it is easy to install. It is simply mounted by hooking two screws or other fastener on the back of the switch cover. Since the switch is wireless and is operated by a replaceable 12 v battery there is no need for hard wiring the switch. Similarly, the smoke detector is wireless and is also simply mounted by screws or similar mechanical fasteners. When the smoke detector sensor detects smoke, the transmitter transmits a signal to the door bell to sound the alarm. Alternatively, the smoke detector could have an additional alarm that is part of and connected so that an alarm would sound both at the smoke detector itself and at the remote alarm through the transmitter and receiver. The door bell may be powered by a 9 V battery or three C size batteries, or other combination of standard batteries easily available on the market. Additionally, the door bell may include a light 47 and a plug 49 for an input power plug in case the consumer wants to use an adapter for 4.5 v that would plug into a standard electrical outlet.

In operation if there is a fire in the location of the smoke detector then the detector will transmit a signal to the doorbell, which will also sound the same corresponding tone as the detector. The door bell is wireless and can be put for example, in the sleeping area of the house, or even outdoors depending on the location of the occupant. If the door bell switch is used when a guest comes to the house then the door bell will sound a second, distinctive sound. This is done to distinguish an emergency from a regular visitor, and the tone will be reflective of that. Additionally, the audio signal produced by the door bell in response to the smoke detector transmitter may be the same or different than the audio alarm produced by the alarm onboard the smoke detector. This difference in audio signal may provide a greater effect on a sleeping or distrcated person who may tune out one of the signals. Each detector and doorbell is individually programmed so that it would prevent alarms sounding off in other homes in instances when two neighbors purchase and use the same product.

While the detailed drawings and specific examples describe exemplary embodiments of a wireless fire detection and door bell system; as well as a security kit and a method for providing the kit, they serve the purpose of illustration only. For example, other units may be added to the system, such as additional smoke detectors or door bells. Additionally, the bell or alarm may be able to provide a plurality of distinct signals in response to each of the additional components. Additionally, the alarm may provide a visual response such as light or provide a vibration in response to the smoke detector and door bell components. The terms alarm, chime, and door bell are all used herein as a device capable of creating an audio signal or sound whether by electronic or mechanical means. Further modifications may be made in the design, arrangement and combination of the elements without departing from the scope of the invention as expressed in the appended claims.

What is claimed is:

1. A wireless fire detection and door bell system comprising:
a wireless smoke detector having a first transmitter and a replaceable power source;
a wireless door bell having a button and a second transmitter activated by depressing the button, the door bell including a second replaceable power source; and
a chime having a receiver and means for producing a first audio signal in response to the first transmitter and a second audio signal in response to the second transmitter.

2. The apparatus of claim 1, wherein the wireless smoke detector includes an onboard alarm that provides a third audio signal.

3. The apparatus of claim 2, wherein the third audio signal is different than the first and second audio signals.

4. The apparatus of claim 3, wherein the chime is portable.

5. The apparatus of claim 4, wherein the chime is programmable to play different audio signals.

6. The apparatus of claim 5, wherein the chime receiver has means to receive a signal transmitted on a signal different than the first and second signals.

7. A security kit for sale in a retail outlet comprising:
a wireless smoke detector having a transmitter with a first frequency;
a wireless door bell having a second transmitter with a second frequency different than the first frequency;
a chime having a receiver and means for producing a first signal in response to the first transmitter and a second different signal in response to the second transmitter; and
fasteners for securing the wireless smoke detector and wireless door bell to a building.

8. The apparatus of claim 1, wherein the smoke detector includes an onborad alarm.

9. The apparatus of claim 2, wherein the onboard alarm produces an audio signal different than the first and second signals.

10. The apparatus of claim 3, wherein the chime is portable.

11. The apparatus of claim 4, wherein the chime is programmable to play different audio signals.

12. The apparatus of claim 5, wherein the chime receiver has means to receive a third signal transmitted from a third transmitter.

13. A method of providing a security kit for sale in a retail outlet to a consumer:
providing a first smoke detector having a first wireless transmitter transmitting a first signal;
providing a door bell button having a second wireless transmitter transmitting a second signal different than the first signal; and
providing an alarm with a receiver configured to receive the first and second signals from the first and second transmitters and to provide a distinct audio signal in response to the first and second transmitters respectively.

14. The method of claim 13, wherein, the first and second signals are transmitted on the same frequency.

15. The method of claim 13, wherein the first and second signals are transmitted on different frequencies.

16. The method of claim 15, wherein at least one of the signals is transmitted at a frequency of 315 Mhz.

17. The method of claim 14 further including the step of providing a second door bell button having a transmitter transmitting a signal different than the first signal.

18. The apparatus of claim, further including providing a light providing fasteners to secure the smoke detector and door bell button to a structure.

19. The method of claim 13, further including programming the alarm to selectively provide different audio signals by the consumer.
